(19) United States
(12) Patent Application Publication
(10) Pub. No.: US 2010/0312537 A1
(43) Pub. Date: Dec. 9, 2010

(54) SYSTEMS AND METHODS FOR PERFORMING A SCREENING PROCESS

(76) Inventors: Anwar Rayan, Kfar-Kabul (IL); Jamal Raiyn, Kfar-Kabul (IL)

Correspondence Address: YORAM TSIVION, P.O. BOX 1307, PARDES HANNA, 37111, IL

(21) Appl. No.: 12/812,956

(22) PCT Filed: Jan. 15, 2009
(86) PCT No.: PCT/IB09/50149

§ 371 Date: Jul. 15, 2010

Related U.S. Application Data
(60) Provisional application No. 61/021,052, filed on Jan. 15, 2008.

(51) Int. Cl. G06G 7/58; G06F 15/18

(52) U.S. Cl. 703/11; 706/12

(57) ABSTRACT

A method of efficiently selecting among a larger number of candidate items at least one item having a higher probability to possess a certain property is disclosed. The method includes providing at least a training dataset of true positive TP items and a training dataset of true negative TN items; selecting at least one binary descriptor; encoding each item in the TP and TN datasets into a binary vector; defining at least one virtual sensor and sensor scoring rules (SSR) therefor, nucleating at least one virtual sensor by calculating the SWS thereof; selecting at least one virtual sensor, and applying it to a query for evaluating integrated inclusive score (IIS) thereof.

### CROSS-REFERENCE TO RELATED APPLICATIONS

The present application claims the benefit of priority to U.S. Provisional Patent Application Ser. No. 61/021,052, filed Jan. 15, 2008, entitled “Intelligent Learning Engine (ILE) Optimization Technology”; the aforementioned application is hereby incorporated herein by reference.

### TECHNICAL FIELD

The present invention, in general, relates to systems and methods for optimization of screening processes. More particularly, the present invention relates to systems and methods providing for efficiently selecting, from a large number of candidate items, an item having a higher probability to have a certain property.

### BACKGROUND ART

The need of obtaining an accurate selection among numerous potential candidates is pivotal in life sciences as well as in other fields of science and technology. Screening methods enabling such selection are often characterized by a high complexity. There are numerous screening methods known in the art, instances of which include the following.

Genetic Algorithms (GAs) have been applied to a number of optimization problems. Such algorithms take their inspiration from the Darwinian principle of evolution: natural selection and survival of the fittest.

A neural network (NN) is an interconnected group of biological neurons. In modern usage the term can also refer to artificial neural networks, which are constituted of artificial neuron. The most interest in neural networks is the possibility of learning.

Support Vector Machines (SVM) is a statistical learning algorithm that is popular in machine learning community and pattern recognitions. A learning machine is first trained to distinguish between two categories from a series of labeled examples and is then used to predict the class membership of previously unseen examples.

Monte Carlo (MC) is a stochastic method which is based on random walks. Generally it comprise the following steps: define a domain of possible inputs, generate inputs randomly from the domain, perform a deterministic computation using the inputs, aggregate the results of the individual computations into the final result.

Simulated Annealing (SA) is a generalization of a Monte Carlo method that has been used for examining the equations of state and frozen states of n-body systems. In an annealing process a melt, initially at high temperature and disordered, is slowly cooled.

Taboo Search (TBS): the goal is to make a rough examination of the solution space, but as candidate locations are identified the search is more focused to produce local optimal solutions. TBS is problem independent and can be applied to a wide range of tasks. However, it cannot guarantee to solve the multiple minima problem in a finite number of steps, and may require long computing times.

Statistical Methods (SMs) employ a model of the objective function to bias the selection of new sample points. These methods are justified with Bayesian arguments that suppose that the particular objective function to be optimized comes from a class of functions that are modeled by a particular stochastic function. Information from previous samples of the objective function can be used to estimate parameters, and this refined model can subsequently be used to bias the selection of points in the search domain. The problem in using SMs is whether the statistical model is appropriate for a problem.

Stochastic elimination approach (ISE): the search is performed for various combinations of basic elements, according to at least one desired property of the combination, which is translatable into a quantitative measurement of the success of the search. Since the number of variables and hence the number of combinations may be very large, preferably samples of combinations are examined.

Bayesian is probabilistic graphical models in which nodes represent random variables, and the arcs represent conditional independence assumptions. When the graph is undirected graphical model is called Markov Random Fields or Markov Networks, which have a simple definition of independence: which means two nodes A and B are conditionally independent given a third set, C, if all paths between the nodes in A and B are separated by a node in C. When the graph is directed graphical models is called Bayesian Networks or Belief Networks.

Hidden Markov Model is the simplest kind of Dynamic Bayesian Networks, which has one discrete hidden node and one discrete or continues observed node per slice. Hidden Markov Model (HMM) is a class of probabilistic models that are generally applicable to time series or linear sequences.

Discriminant analysis (DA) is a very useful statistical tool. It takes into account the different variables of an object and works out which group the object most likely belongs to. In protein classification issue, it uses concise statistical variables based on physico-chemical properties of protein sequences.

Hence a screening method enabling to select, among numerous potential candidates, a fewer candidates having a certain property shall be valuable for those skilled in the art having the benefit of this disclosure.

### SUMMARY OF THE INVENTION

There is provided in accordance with some embodiments of the present invention a method for optimization of screening processes, which inter alia can be used for selection of a candidate molecule for being a drug for a certain disease, for a protein to belong to a certain family, various analyses in fields of bioinformatics and cheminformatics, etc. . . .

This general optimization technology could properly be applied in other scientific disciplines and technological fields, which in a non-limiting manner include: finding within a certain population of people individuals with the highest probability to develop certain diseases, finding optimal alternatives of investment in stock exchange markets, optimal allocation of resources in cellular communication systems, finding optimal transportation alternatives in complex, multi-factor situations. Only for the sake of brevity in this disclosure a specific field of application will be exemplified, namely the example provided infra is from the field of bioinformatics.

The test cases that were chosen to empirically evaluate the efficacy of the method of the present invention were: (1) molecular activity indexing of biologically active molecules versus biologically non-active molecules; (2) identification and classification of proteins, such as G-protein coupled receptors; (3) homology-based modelling of serine proteinases.

### BRIEF DESCRIPTION OF THE DRAWINGS

The present invention will be understood and appreciated more fully from the following detailed description taken in conjunction with the appended drawings in which:

FIG. 1 is a plot of curves representing the performance of the method of the present invention versus Pipeline Pilot integrated with Bayes model as optimization tool and Extended connectivity fingerprints (ECFPs) as molecular descriptors, and a random model.

FIG. 1 is a plot of curves representing the performance of the method of the present invention versus 5HT2a antagonists algorithm.

### DISCLOSURE OF THE INVENTION

Illustrative embodiments of the invention are described below. In the interest of clarity, not all features of an actual implementation are described in this specification. It will be appreciated that in the development of any such actual embodiment, numerous implementation-specific decisions must be made to achieve the developers' specific goals, such as compliance with system-related and business-related constraints, which vary from one implementation to another. Moreover, it will be appreciated that such a development effort might be complex and time-consuming, but would nevertheless be a routine undertaking for those of ordinary skill in the art having the benefit of this disclosure.

In accordance with some embodiments of the present invention two different datasets are utilized for the implementation of the screening process. First dataset contains items which are true positive (TP) matches to the query and the second dataset contains items which are true negative (TN) matches to the query. These datasets are divided into four sets—TP training set and TN training set and TP testing set and TN testing set. Usually ⅔ of the items are the training set and ⅓ in the testing set.

The items in the datasets are then encoded as a binary expression (hereinafter binary vector) comprising a plurality of binary descriptors. Each descriptor characterizes a certain property of interest. A binary descriptor may contain one or more binary integers, each integer being 1 or 0. The choice of descriptors is application dependant and requires knowledge of the specific objective for which the method of the present invention is implemented. If for instance the property of interest is the affinity to water, a binary descriptor comprising single binary integer of 1 can be assigned to hydrophilic amino acids and of 0 to hydrophobic amino acids. Provided that the property is quantitative, a binary descriptor comprising a string of binary integers can be used to represent a pertinent numeric ranges of a given property; e.g. molecular weight can be described by ten binary integers, for instance below 50, 50 to 100, etc.

The sequence of a particular protein can be encoded by a binary vector, in which binary descriptors having the values of 1 are assigned to a certain amino acid, at a given position within protein's sequence, whereas binary descriptors having the value of 0 are assigned to all the remaining amino acids at said given position. Thus, a vector representing the sequence of a protein may contain 20*N binary descriptors, in which N is number of amino acids in the primary sequence multiplied 20 types of standard amino acids used by cells for production of proteins. It should be noted that the method of the present invention can be implemented in a dynamic environment, wherein the training datasets are modified, whereby the performance of the method is altered and the efficacy thereof is respectively enhanced.

The binary vector may contain versatile information. For instance, the first binary integer in a binary vector may encode for hydrophobic/hydrophilic property (respectively 1 or 0) of a given amino acid, followed by a string of ten binary integers encoding the molecular weight of the aforesaid amino acid, followed by a string of twenty binary integers encoding particular identity of the aforesaid amino acid, e.g. alanine, glycine, etc. After the first group of binary integers encoding the aforementioned properties of the first amino acid, there is the second group of binary integers encoding the same properties for the second amino acid in the sequence.

### Sensors Nucleation

A virtual sensor, as referred herein, is a quantitative indicator (hereinafter referred to as sensor's weight score or SWS) associated with a portion of the binary vector that represents a fragment or sub-fragment (e.g. single amino acid, subset of amino acids, residue, moiety, etc.) within the item in the datasets and or the query. SWS are calculated according to sensor scoring rules (hereinafter SSR). SSR are rules, which are typically different for scoring the vectors of TP and TN items, according to which the SWS of a given sensor is calculated and or modified. SSR comprise mathematical formulae which represent the weight we want to assign for an identity/similarity in a certain property, among the items in the datasets and/or the query, as encoded by their binary vectors.

In the example of a protein, the virtual sensors can be derived from the sequence thereof, in the following manner. The sequence of the protein is portioned into frames, a frame being a subset of amino acids from the sequence of the protein. The number of amino acids in each frame is a variable which can be dynamically adjusted to obtain optimal results. For example if a certain protein comprises 200 amino acids, frames comprising 10 amino acids can be selected; thence the frames will consist amino acids 1 to 10, 2 to 11, 3 to 12, etc. In this specific case 191 frames can be created and hence 191 corresponding sensors will be respectively defined.

Thence, the vectors of a part of the training set, preferably including at least 2 members of the TP training set and approximately a half of the TN training set, is randomly selected (hereinafter referred to as sensor nucleation set or SNS) and thereafter is used for the calculation of the SWS of the virtual sensors. The sequence of the first TP item in the SNS is portioned into frames, which are represented by the corresponding portions in its binary vector. Each frame is assigned with its SWS, which is calculated according to the SSR. Frame with its SWS is referred to as sensor. For instance, the SSR may assert that if the amino acid in the third position within a frame is glycine, then the SWS will be increased by 3 or multiplied by 2 or altered in any other manner. Then the SWS for the second frame within the first TP item in the SNS is calculated. This step is repeated for all the frames within the first TP item, as represented by the corresponding portions in its binary vector. Thence the SWS for the first frame within the second TP item in the SNS is modified according to the SSR. These steps of are repeated for all the items in the SNS; this process referred to as nucleation.

It should be noted that SSR are typically different for scoring of TP and TN items. Thus in the example of the aforementioned SSR, asserting that if the amino acid in the third position within a frame is glycine, then the SWS will be increased by 3, is true for a TP item, the SSR for a TN item can be that SWS will be decreased by 3 if the amino acid in the third position within a frame is glycine, or that SWS will be increased by 3 if the amino acid in the third position within a frame is not glycine.

After the vectors of the TP proteins from the SNS were processed together with a larger number of the vectors of TN proteins from the SNS to establish virtual sensors having particular SWSs, some sensors will be accredited with a higher SWS, which represent frames that have a higher similarity/identity among the TP items. The number of items in the sensor nucleation set and the number of frames defining the sensors can be empirically chosen according to the application and/or database.

SSRs: Logical XOR and XNOR Multiplication Matrices of Sensors with Vectors

Among various SSR logical XOR and XNOR multiplication matrices of sensors with portions of the vectors is possible. The XNOR can be used for multiplication of sensors with portions of the vectors of TP dataset; whereas XOR can be used for multiplication of sensors with portions of the vectors of TN dataset. Thus if at a given position in a sensor the binary integer is 1, the result of 1 will be given for a TP item in which at the same position the binary integer is also 1, and vice versa; whereas the result of 1 will be given for a TN item in which at the same position the binary integer is 0, and vice versa.

The SWS for each corresponding portion in a vector can be calculated as a summary.

A11*D11+A12*D12+ . . . B*X

Where A (i,j) is a factor for each weight at position j, D(i,j) is the SWS of a sensor i at position j, B is the factor for the X weight and X is the result of the vector XOR operation. At the first iteration each of the factors is 1. The set of factors for weights of descriptors, the descriptor weights at each position and the B factor are named sensors, with a one-one correspondence between a sensor and a corresponding portion in a vector.

### Sensors Optimization

A graphic plot of the scores is preferably generated, in which the x axis are the items numbered separately for true positive and true negative and the y axis is the SWS for various sensors. For the SNS for the TP items the score of the frames which are the basis of the sensor and for the TN items the score of the frames with the highest scores.

The separation score is then evaluated using the MCC method (Matthews correlation coefficient) and the gap between the lowest score of the true positive items in the SNS and highest score true negative frames therefrom is determined.

The nucleated sensors are applied to all the remaining items within the training set, the true positive and true negative. A bigger number of items in the training set entails sensors with higher statistical significance.

The following procedure can be employed:
1. Each sensor is applied to all of the portions of a vector and the resulting SWS is evaluated.
2. For each sensor a group, typically between 10 to 30, depending on the total number of sensors and the range of scores, of portions in the vectors with the highest score is selected.
3. We then select combinations of vector's portions (one from each group) which are compatible with the order of the frames within the protein the vectors encodes for and discard the others. This operation reduces dramatically the number of combinations for which a combined score for an item and or query, being the integrated inclusive score (hereinafter IIS) for a vector to which a set of sensors is applied, has to be calculated and thus the calculation time.

The IIS is calculated for the next item in the TP training set. The procedure is repeated from scratch the next item in the TP training set, with three TP proteins are now being included in the nucleus instead of two. Solely items with IIS exceeding a predetermined value can optionally be selected.

This procedure is repeated until all TP proteins have been included in the nucleus. Optionally, the process can be stopped when full separation is achieved.

### Selection of the Sensors

The sensors resulting the processing of the items in the training set are then tested against the testing set. The criteria for quality assurance of the sensors can be an absolute or substantial absence of false positive and or false negative matches, resulting the processing of the items in the testing set. The quality assurance for a set of sensors can be further validated using false positive and false negative cases in the tests. The IIS for false positive and false negative items can be evaluated using the routines described above. The SSRs are then can be modified to obtain improved separation between the TP and TN sets. This method is applicable for identification of false positive and false negative cases in practice.

Among the sensors quality of which was assured by the testing against the testing set, at least one sensor is selected according to the following rules.
4. The sensors having SWS exceeding predetermined threshold vale are selected.
5. Optionally, the sensors are selected in accord with their order of succession along the binary vector. Thus the order of the sensors will be consistent with the order the fragments or sub-fragments they represent in the datasets items.
6. Preferably, an ordered set of non-overlapping high score sensors is selected. Thus in the example of the protein, frames that do not cover amino acids at positions that are common to two frames can be selected.

The selected sensors are further used for the screening process.

### Maximization of the Virtual Sensors Efficiency

By this mechanism a better separation between the true positives and the true negatives as well as increase the gap between the true positive lowest score and true negative highest score can be achieved.

Different factors can be applied, for instance either 0.1 or 0.5 at presents in order to reduce the computational task, to the descriptors' weights and these factors are determined so that the ratio between the lowest score protein in the TP set, corresponds to less fitting items, and the highest score protein in the TN is maximal, corresponds to maximal gap between TP and TN sets.

The selected sensors are applied to a query/s and inter alia can be efficiently utilized for:
7. Molecule Activity Indexing—the system predicts the activity index of molecules to specific targets or specific task;
8. Identification and Classification of Proteins—the system predicts whether a certain protein, described by its amino acids, belongs to a certain family or sub-family of proteins.
9. Identification of GPCR's—the system predicts whether a protein is a GPCR or is not;
10. Homology Modeling—The system predicts the three-dimensional structures of proteins with high accuracy based on homology modeling to other template targets.

### Example 1

### Test No. 1

Comparison between the method of the present invention and the state-of-the-art methods is exemplified infra. In this example the method of the present invention was employed in the field of chemoinformatics in order to evaluate Molecule Activity Index (MAI). Chemoinformatics tools are employed inter alia to increase the probability of the identification of bioactive compounds. The method of the present invention was compared to other approaches using six different data sets (please refer to tables 1,2,3).

A high throughput screening test, in which a dataset of 176000 compounds was tested for their inhibitory activity against a chemokine receptor, was performed. The SSRs were set for indexing of molecular activity of inhibitory effect activity against a chemokine receptor. The active and inactive compounds were divided randomly into training and testing sets. The training set contained 258 active compounds and 4200 inactive compounds whereas the test set contained 128 active compounds and 171430 inactive compounds. A compound was considered active if it has an IC₅₀ of <200.

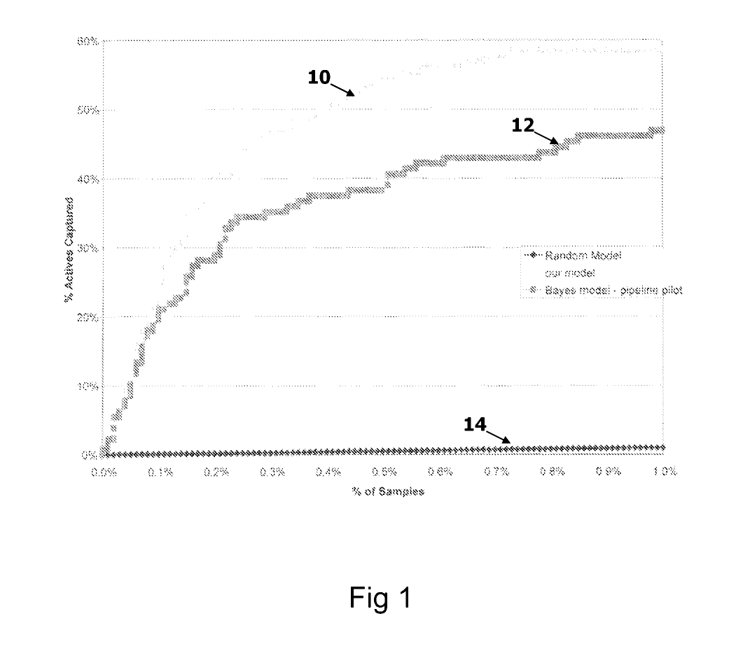

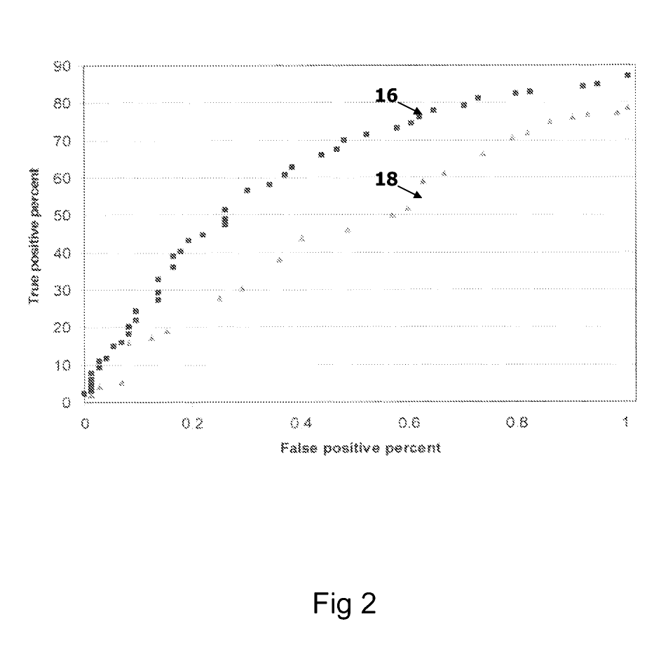

Reference is now made to FIG. 1, in which curve 10 represents the performance of the method of the present invention, curve 12 represents the tool of Pipeline Pilot integrated with Bayes model as optimization tool and Extended connectivity fingerprints (ECFPs) as molecular descriptors folded into 2048 bits, whereas curve 14 represents a random model.

### Test No. 2

Comparison of the method of the present invention implemented for molecular bioactivity indexing versus to in-house tool developed by a big pharma company, known as 5HT2a antagonists, was performed to evaluate the relative efficacy thereof. Reference is now made to FIG. 2, in which curve 16 represents the performance of the method of the present invention, whereas curve 18 represents the performance of the 5HT2a antagonists algorithm; the top 1% of the screened dataset is presented.

### Test No. 3

In Table 1, presented infra, the results of a virtual high throughput screening of four datasets (DS) of 17,000 compounds each; each DS was tested for its respective query. The performance of various algorithms known in the art was tested vis-à-vis the method of the present invention.

TABLE NO. 1

| | DS1 - | DS2 - | DS3 - | DS4 - |
|---|---|---|---|---|
| Algorithm | top 1% | top 1% | top 1% | top 1% |
| Naïve Bayes | 15% | 32% | 33% | 52% |
| Naïve Bayes | 13% | 31% | 32% | 46% |
| folded | | | | |
| RP (100 trees, | 12% | 47% | 26% | 53% |
| gini) | | | | |
| RP (100 trees, | 13% | 43% | 27% | 54% |
| chi squared) | | | | |
| RP(10 trees, | 13% | 47% | 26% | 40% |
| chi squared) | | | | |
| The method of | 24.7% | 54.6% | 53.5% | 59.5% |
| the present | | | | |
| invention | | | | |

### Example 2

### Test No. 1

Novel computational methods are required in order to improve our ability to deal with the vast amount of information that emerges from newly sequenced proteins and DNA, in order to link between sequences and functions, also known as classification, and to transform sequences into structures, 3-D structure prediction. The method of the present invention is exemplified hereunder by the determination of whether a specific protein belongs to the GPCR family or does not belong to this family, as an identification and classification of proteins (ICP) application. Protein identification and classification as well as multiple sequence alignment can be a considerable hard problem in terms of nondeterministic polynomial-time hard (an NP-hard problem); the number of solutions grows exponentially with the number of amino acids in the sequence or the number of residues on a moiety. 167 proteins, among which 31 were acetylcholine receptors, 44 adrenoreceptors, 38 dopamine receptors, 54 seratonins, were analyzed and compared to results of two other methods known in the art, namely Chou1, otherwise known as Covariant-discrimination algorithm (David W. Elrod and Kuo-Chen Chou, 2002, A study of the correlation of G-protein-coupled receptor types with amino acid composition, Protein Engineering, 15 (9), 713-715); and Raghava2 with Support Vector Machine algorithm developed for amine receptors classification (Manoj Bhasin and G.P.S. Raghava, 2005, GPCRsclass: a web tool for the classification of amino type of G-protein-coupled receptors, Nucleic Acids Research, 33, W143-W147).

By the Chou1 merely 67.74% of the TP acetylcholine items were classified as TP matches, 88.64% of the TP adrenoreceptor items were classified as TP matches, 81.58% of the TP dopamine items were classified as TP matches, 88.89% of the TP seratonins items were classified as TP matches. In summary an overall 83.23% of accuracy was exhibited by the Chou1 method.

By the Raghava2 93.6% of the TP acetylcholine items were classified as TP matches, 100.00% of the TP adrenoreceptor items were classified as TP matches, 92.1% of the TP dopamine items were classified as TP matches, 98.2% of the TP seratonins items were classified as TP matches. In summary an overall 96.4% of accuracy was exhibited by the Raghava2 method.

By the method of the present invention 100% of the TP acetylcholine items were classified as TP matches, 100.00% of the TP adrenoreceptor items were classified as TP matches, 100% of the TP dopamine items were classified as TP matches, 100% of the TP seratonins items were classified as TP matches. In summary an overall 100% of accuracy was exhibited by the method of the present invention.

### Test No. 2

In Table 2, presented infra, the results of a virtual high throughput screening representing the performance of various algorithms known in the art applied fir the identification of GPCR proteins tested vis-à-vis the method of the present invention are shown.

TABLE NO. 2

| | Prediction |
|---|---|
| Method | accuracy in % |
| SVM- dipeptide based | 99.5 |
| SVM- aa composition based | 96.5 |
| BLAST | 86.5 |
| PROSITE pattern | 92.0 |
| Pfam profile HMMs | 97.0 |
| PRINTS | 99.0 |
| PROSITE profile using pfscan | 97.0 |
| QFC algorithm | 99.5 |
| Linear discriminant analysis | 98.7 |
| Quadratic discriminant analysis | 98.5 |
| Logistic discriminant analysis | 97.7 |
| K-nearest nighbor method (KNN) | 98.3 |
| The method of the present invention | 100.0 |

### Test No. 3

In Table 3, presented infra, the results of a virtual high throughput screening representing the performance of various algorithms known in the art, applied for the classification of GPCR proteins to their respective super families A, B or C, tested vis-à-vis the method of the present invention, are shown.

TABLE NO. 3

| | Prediction |
|---|---|
| Method | accuracy in % |
| SVM- dipeptide based | 99.5 |
| SVM- aa composition based | 96.5 |
| BLAST | 86.5 |
| PROSITE pattern | 92.0 |
| Pfam profile HMMs | 97.0 |
| PRINTS | 99.0 |
| PROSITE profile using pfscan | 97.0 |
| QFC algorithm | 99.5 |
| Linear discriminant analysis | 98.7 |
| Quadratic discriminant analysis | 98.5 |
| Logistic discriminant analysis | 97.7 |
| K-nearest nighbor method (KNN) | 98.3 |
| The method of the present invention | 100.0 |

### Test No. 4

In Table 4, presented infra, the results of a virtual high throughput screening representing the performance of various algorithms known in the art, applied for the classification of GPCR proteins on their respective first-subfamily level, e.g. amine, peptide olfactory, as tested vis-à-vis the method of the present invention, are shown.

TABLE NO. 4

| | Prediction |
|---|---|
| Method | accuracy in % |
| SVM | 88.4 |
| BLAST | 83.3 |
| SAM-T2K HMM | 69.9 |
| kernNN | 64.0 |
| Decision tree | 77.3 |
| Naive Bayes | 93.0 |
| The method of the present invention | 99.8 |

### Test No. 5

In Table 5, presented infra, the results of a virtual high throughput screening representing the performance of various algorithms known in the art, applied for the classification of GPCR proteins on their respective second-subfamily level, e.g. adrenergic, dopamin, histamine, as tested vis-à-vis the method of the present invention, are shown.

TABLE NO. 5

| | Prediction |
|---|---|
| Method | accuracy in % |
| SVM | 86.3 |
| SVMtree | 82.9 |
| BLAST | 74.5 |
| SAM-T2K HMM | 70.0 |
| kernNN | 51.0 |
| Decision tree | 70.8 |
| Naive Bayes | 92.4 |
| Covariant-discriminant | 83.2 |
| The method of the present invention | 100.0 |

### Example 3

### Homology Modeling

Accurate multiple sequence alignment (MSA) is important step that may improve the accuracy of pairwise sequence alignments, minimize misalignments and generate more accurate 3-D models. If a family of proteins which shares the same fold and contains more than one member, the method of the present invention can be used to interpret the data accumulating in sequence database, and thereby to perform accurate multiple sequence alignment and construct the best comparative model.

To assess the performance of the method of the present invention, the entries of 124 unique proteins which belong to serine protease family were retrieved from the Brookhaven Protein Databank (PDB). Sequence identity score was calculated for each pair of sequences. The method of the present invention was employed to optimally align the sequences. The residues from the multiple sequence alignment were found merely in 98 proteins. 28 proteins lack coordinates of one residue at least in their 3-D experimentally determined structures. The alpha carbons (Cα) for residues of selected proteins were extracted from the PDB structures and structurally superimposed.

The quality of the models was assessed via superimposition of the predicted homology-based model and the X-ray structure of the protein and then, measurement of the Cα root mean square deviation (Cα RMSD).

In Table 6, presented infra, the results of a homology modeling representing the performance of the method of the present invention, applied for the target-template identity classes in serine protease family are shown.

TABLE NO. 6

| | | Percent^{π} | Percent | Percent |
|---|---|---|---|---|
| Percent | Total | models with | models with | models with |
| sequence | number of | RMSD lower | RMSD lower | RMSD lower |
| identity^{α} | models^{β} | than 1 Å | than 2 Å | than 3 Å |
| 25-29 | 15 | 40 Ω | 100 | 100 |
| 30-39 | 883 | 28 | 98 | 100 |
| 40-49 | 2365 | 50 | 99.9 | 100 |
| 50-59 | 423 | 75 | 100 | 100 |
| 60-69 | 51 | 90 | 100 | 100 |
| 70-79 | 181 | 100 | 100 | 100 |
| 80-89 | 289 | 100 | 100 | 100 |
| 90-95 | 44 | 100 | 100 | 100 |

α: Sequence identity range between target and template.

β: Total number of models in any given sequence identity range. The table summarizes 4251(1201) model template pairs.

π: Percent of models, in a given sequence identity range, deviates by 1 Å or less from the corresponding experimental control structure. The following columns provide these percentages for other RMS deviations.

Ω: secondary structure segments were used for model generation and RMSD evaluation of the performance of the method of the present invention, as tested on all the 160 residues.

The multiple sequence alignment matrix obtained by performing the method of the present invention on the selected dataset of serine proteases, was processed as described below, in order to specify which parts of the whole set of sequences to select for comparative modeling. A voting approach, in which each amino acid contributes to the conservation at a sequence position according to its frequency in that particular position, according to Equation 1, was employed. These frequencies were measured in all sequences in the dataset.

$${C}_{ij} = \frac{{n}_{ij}}{k} * 100 \% \qquad Equation No . 1$$

In which Cᵢⱼ is the conservation factor for residue type i at sequence position j, nᵢⱼ is the number of sequences, which have amino acid i at position j in the multiple alignment, and k is the total number of sequences in the dataset. Positional Conservation Threshold (PCT) was defined as conservation factor for residue type i at sequence position j, in accordance with Equation 1, to be above a specified threshold. Employing position conservation threshold (PCT) to refine models is recommended as better homology-based models was obtained.

1. A method of efficiently selecting among a larger number of candidate items at least one item having a higher probability to possess a certain property, said method comprising the steps of:
providing at least a training dataset of true positive TP items, wherein each TP item is known to possess said certain property, and a training dataset of true negative TN items, wherein each TN item is known not to possess said certain property;
selecting at least one binary descriptor, wherein said binary descriptor comprising at least one binary integer, and wherein at least on of said binary descriptors characterizes at least said property;
encoding each item in said TP and TN datasets into a binary vector; wherein said binary vector is an expression comprising a plurality of binary descriptors;
defining at least one virtual sensor and sensor scoring rules (SSR) therefor, said virtual sensor being a quantitative indicator of sensor's weight score (SWS) associated with a portion of a binary vector representing a fragment or sub-fragment within item in said datasets; wherein said SWS is calculated according to said sensor scoring rules (SSR); wherein said SSR comprise mathematical formulae which represent the score to be assigned for an identity/similarity in a given property;
nucleating at least one virtual sensor by calculating said SWS by means of application of said SSR to at least two TP items and a plurality said TN items, being sensor nucleation set (SNS);
selecting at least one virtual sensor, preferably having a higher SWS;
applying said at least one selected sensor to a query and evaluating integrated inclusive score (IIS) thereof.

2. The method as in claim 1, further comprising a TP testing dataset and a TN testing dataset, used to assure the quality of said virtual sensors.

3. The method as in claim 1, wherein said binary descriptors characterize a property selected from the group consisting of: a qualitative property and a quantitative property.

4. The method as in claim 1, wherein said vector contains versatile information comprising a plurality of said binary descriptors.

5. The method as in claim 1, wherein said sensor for a protein comprising at least one frames within the sequence of said protein.

6. The method as in claim 1, wherein said SSR are different for TP and TN items.

7. The method as in claim 1, wherein said SSR comprise a logical multiplication matrix selected from the group consisting of: an XOR matrix and XNOR matrix.

8. The method as in claim 1, wherein said virtual sensors are subjected to optimization.

9. The method as in claim 8, wherein said optimization comprising evaluating the separation score using the Matthews correlation coefficient (MCC) method and/or the gap between the lowest score for TP items and the highest score for TN items.

10. The method as in claim 8, wherein said optimization comprising generating a graphic plot of the scores, in which the x axis is the items numbered separately for TP and TN items and the y axis is the SWS for various sensors.

11. The method as in claim 8, wherein said optimization comprising applying each sensor to all the portions of a vector and evaluating the resulting SWS.

12. The method as in claim 8, wherein said optimization comprising applying said nucleated sensors to the remaining items in said TP training dataset and said TN training dataset.

13. The method as in claim 1, wherein at said step of selecting said virtual sensors are selected in accord with their order of succession along a binary vector; wherein the order of said selected sensors is consistent with the order the fragments or sub-fragments they represent in the datasets items.

14. The method as in claim 13, wherein said order of said selected sensors is reflected in said IIS.

15. The method as in claim 1, wherein at said step of selecting said virtual sensors the sensors are selected as an ordered set of non-overlapping high SWS sensors.

16. The method as in claim 1, wherein said virtual sensors are subjected to maximization of their efficiency.

17. The method as in claim 16, wherein said maximization of said sensors efficiency comprising altering said SSR.

18. The method as in claim 1, employed for any selected from the group consisting of: molecule activity indexing, identification and classification of proteins, homology modeling.
